(19) United States
(12) Patent Application Publication
(10) Pub. No.: US 2003/0212819 A1
(43) Pub. Date: Nov. 13, 2003

(54) Transferring data wirelessly between digital devices

(76) Inventors: Ryan S. Russell, Hillsboro, OR (US); Vareck Bostrom, Aloha, OR (US)

Correspondence Address: FISH & RICHARDSON, PC, 4350 LA JOLLA VILLAGE DRIVE, SUITE 500, SAN DIEGO, CA, 92122, US

(21) Appl. No.: 10/142,410

(22) Filed: May 9, 2002

(51) Int. Cl. G06F 15/173

(52) U.S. Cl. 709/238

(57) ABSTRACT

Data is transferred between a wireless device and another digital device by using the wireless digital device to detect the other digital device. The wireless digital device determines whether to transfer data to the other digital device based on information related to the data stored on the wireless digital device and provided by a user of the wireless digital device prior to the detection of the other digital device. If the wireless digital device determines to transfer the data, the data transfers from the wireless digital device to the other digital device, without interacting with the user.

### TECHNICAL FIELD

This application relates to transferring data wirelessly between digital devices.

### BACKGROUND

Many digital devices, including small hand-held personal digital assistants (PDAs) and mobile telephones are able to transfer data wirelessly anywhere the device can be carried. Such wireless devices also provide data storage and processing for a variety of functions such as keeping calendars and storing address book information.

### DESCRIPTION OF DRAWINGS

FIG. 1 shows a PDA and another digital device.

FIG. 2 shows two PDA's.

FIG. 3 is a block diagram of a PDA.

FIG. 4 is a flow diagram of a file transferring procedure.

FIG. 5 shows a PDA and a wall-mounted data interface.

### DESCRIPTION

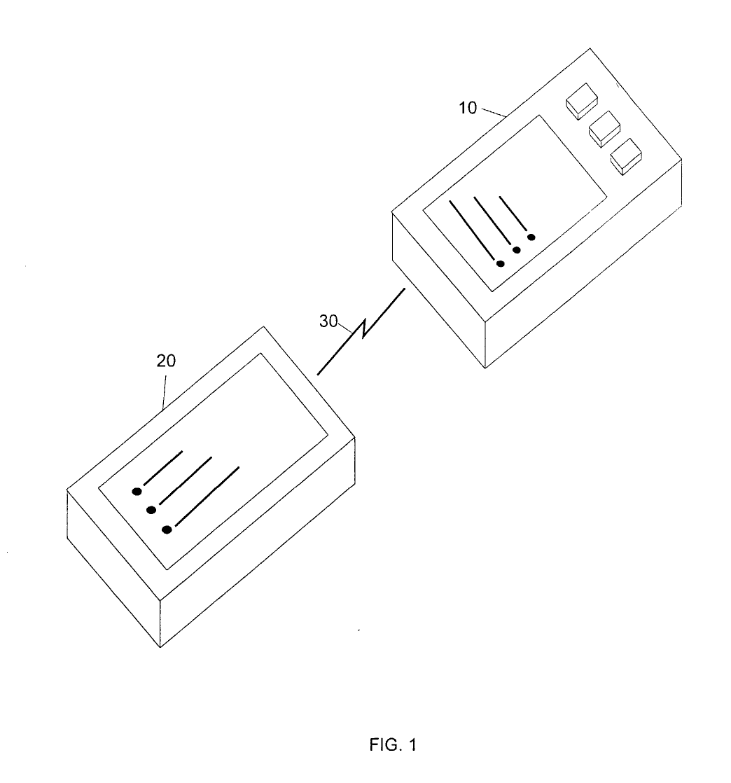

As shown in FIG. 1, in some implementations, data can be transferred between a wireless digital PDA 10 and another digital device 20 without a user being involved during the transfer. When the two devices are within communication range of each other, the PDA 10 detects the presence of the other digital device 20. Based on information provided by the PDA's user, prior to the detection of the other digital device 20, PDA 10 determines whether to exchange data with the other digital device. If the PDA 10 determines to exchange data, data is transferred over a wireless link 30, between the PDA 10 and the other digital device 20. The data exchange may be completed efficiently and transparently without the PDA 10 waiting for user interaction.

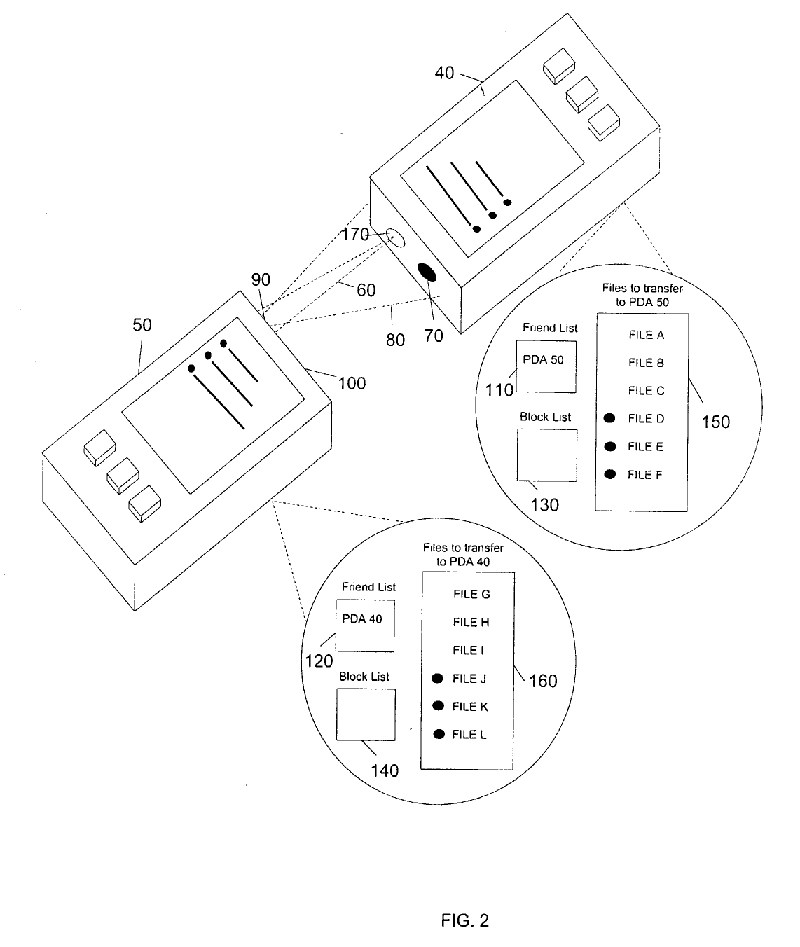

In the example shown in FIG. 2, one PDA 40 detects a second PDA 50 and exchanges files without interacting with a user of PDA 40 after the detection of the second PDA 50. After detection, files are exchanged between PDA 40 and PDA 50 over a wireless radio frequency (RF) link 60. By exchanging files between PDA 40 and 50, information such as email messages, schedules, phone book listings, or multimedia files may be transferred. By not interacting with the user, the information exchange occurs without alerting the user. Since the user may have previously decided to allow the information exchange, the user can perform other tasks without be distracted during the exchange.

PDA 40 includes a detector 70 which is configured to automatically detect an RF signal broadcast 80 from a communication interface 90 (out of view) included in PDA 50. The RF broadcast 80 announces the presence of PDA 50 and is encoded with information to allow PDA 40 to identify PDA 50 as the source of the RF broadcast. Detector 70 detects the RF broadcast 80 when PDA 50 is within a detectable range of PDA 40. PDA 50 also includes a detector 100 (out of view) that may detect RF broadcasts transmitted by PDA 40, or other wireless digital devices, which may similarly contain encoded information to identify PDA 40 as the source of the broadcast. Thus, detector 100 allows PDA 50 to determine, as was the case for PDA 40, if another PDA is within a detectable range for file exchanging without interacting with a user. Either PDA 40 or PDA 50 may also use, for example, a digital signature to authenticate for secure file transferring.

After PDA 40 detects PDA 50, PDA 40 decodes the received RF broadcast signal 80 and identifies PDA 50 as the broadcasting source. Next, PDA 40 determines, again without user interaction, whether to exchange files with PDA 50. PDA 40 may determine to exchange files if PDA's 50 identification appears in a “friend” list 110 stored, for example in a memory of PDA 40. The “friend” list 110 may contain a list of identifiers of PDA's with which PDA 40 has been authorized to exchange files. Generally, the user of PDA 40 would create, store, modify, and maintain this “friend” list 110 on PDA 40 before the time when detection of other PDAs, such as PDA 50 occurs. PDA 50 may also store its own “friend” list 120, for example in a memory, to authorize file exchanges between PDA 50 and other PDA's detected by PDA 50.

After PDA 40 detects PDA 50, PDA 40 accesses the “friend” list 110 to determine if PDA 50 is on the list. If PDA 50 is on the “friend” list 110, as is the case here, files may then be exchanged between PDA 40 and PDA 50 without interacting with the user of PDA 40. However, if PDA 50 is not on the “friend” list 110, PDA 40 will not exchange files unless, for example, the user of PDA 40 authorizes the file exchanging at that time. Thus, PDA 40 may prompt the user of PDA 40 to enter PDA's 50 identity into the “friend” list 110 after detecting PDA 50.

PDA 40 may also store a “block” list 130, for example in a memory, which may identify PDA's with which PDA 40 is prohibited from exchanging files. Similar to the “friend” list 110, the “block” list 130 may be created by the user of PDA 40 before PDA 50 is detected. If PDA 50 was entered into the “block” list 130, PDA 40 would block file exchanging with PDA 50, again without interacting with the user of PDA 40. In this particular example “block” list 130 contains no identification for PDA 50. Thus, PDA 40 is not blocked from exchanging files with PDA 50. PDA 50 may similarly store, for example in a memory, a “block” list 140 that contains a list of PDA's with which PDA 50 is prohibited from exchanging files. So, if PDA 50 detected a broadcast from another PDA, PDA 50 may access the “block” list 140 to determine if file exchanging is prohibited with that particularly detected PDA.

Once PDA 40 has detected, identified, and determined to exchange files with PDA 50, files 150 stored on PDA 40 and files 160 stored on PDA 50 may be exchanged. Prior to PDA 40 detecting PDA 50, files 150 and files 160 may be tagged (chosen and then marked as available for transfer) respectively by the PDA that stores the files. For example, files A, B, C, D, E, and F may be tagged by PDA 40 for transfer to PDA 50 and files G, H, I, J, K, and L may be tagged by PDA 50 for transfer to PDA 40. The files 150 may also just be tagged for exchanging with PDA 50 or the files may be tagged for exchanging with other PDA's not yet detected by PDA 40.

To transfer files from PDA 40 to PDA 50, files 150 are encoded within RF signals, transmitted from a communication interface 170, included on PDA 40, over the wireless RF link 60, received by the communication interface 90, and stored on the PDA 50. Similarly, to transfer files from PDA 50 to PDA 40, files 160 are encoded within RF signals, transmitted from the communication interface 90 over the wireless RF link 60, received by the communication interface 170, and stored on the PDA 40. Each file transfer occurs automatically without the user of PDA 40 interacting with the PDA 40 during the file exchange. The file may also be encrypted for secure transferring.

PDA 40 may also monitor the file exchanging, between PDA 40 and PDA 50, for interruptions and may also execute procedures if interruptions occur. For example, after PDA 40 and PDA 50 begin exchanging files 150 and 160, the distance between the two PDA's may grow to exceed the communication range of the communication interface 170 or the communication interface 90. By exceeding the communication range, the wireless RF link 60 may degrade and files may not properly transfer. In another interruption example, an object may come between PDA 40 and PDA 50 and may block RF signals propagating across the wireless RF link 60. Blocking RF signals within the wireless RF link 60 may cause the file transferring to halt.

In either interruption example, for a period of time PDA 40 may not receive the RF signals containing the files 160 due to the interruption. PDA 40 may “time out” if the RF signals are not received within a predetermined time period. If PDA 40 does “time out”, PDA 40 may determine that the wireless RF link 60 is not operating and PDA 40 may stop the files 150 from transferring to the PDA 50.

In another example of interrupting the file exchange, PDA 40 may detect PDA 50 re-broadcasting RF signals 80 to again announce the PDA's 50 presence. PDA 40 may then determine that PDA 50 is no longer transferring files 160 and is re-broadcasting 80 its identification in an attempt to re-establish the wireless RF link 60 for file exchanging.

After the interruption has occurred and PDA 40 stops transferring files, due to the interruption, PDA 40 may, without interacting with its user, tag the files that were slated for transfer to PDA 50, but were not transferred due to the interruption. For example, individual files A, B, C, D, E, and F, of files 150, are to be transferred from PDA 40 to PDA 50, however only files A, B, and C actually are transferred before the interruption occurs. PDA 40 may then tag files D, E, and F (each tagged here with a bullet) for transferring once the wireless RF link 60 between PDA 40 and PDA 50 is re-established. Similarly, PDA 50 would tag files J, K, and L if only files G, H and I were actually transferred to PDA 40 before the interruption. In another embodiment, PDA 40 and/or 50 may tag a portion of a file that was not transferred due to an interruption. In that embodiment, the tagged portion, of that file, would be transferred after re-establishing the RF link 60.

After tagging the non-transferred files, to re-establish the wireless RF link 60 the PDA 40 may wait for detector 70 to re-detect PDA 50 re-broadcasting 80 RF signals announcing its presence. Once PDA 40 re-detects PDA 50, re-identifies PDA 50, and determines PDA 50 is still on the “friend” list 110, file transferring may continue by PDA 40 transferring files D, E, and F to PDA 50 and PDA 50 transferring files J, K, and L to PDA 40.

When PDA 40 first detects, identifies, and determines to exchange files with PDA 50, PDA 40 may also probe PDA 50, without interacting with the user of PDA 40, in an attempt to achieve efficient and/or secure file transferring. PDA 40 may probe PDA 50 by decoding additional information encoded in the RF signals broadcast 80 by PDA 50 announcing its presence. For example, PDA 40 may decode an encryption scheme to be used on the transferred files, or decode a digital signature, or PDA 40 may decode transmitting and receiving parameters (e.g., data transmission rate) of PDA 50 so that the parameters may be matched for efficient file exchange.

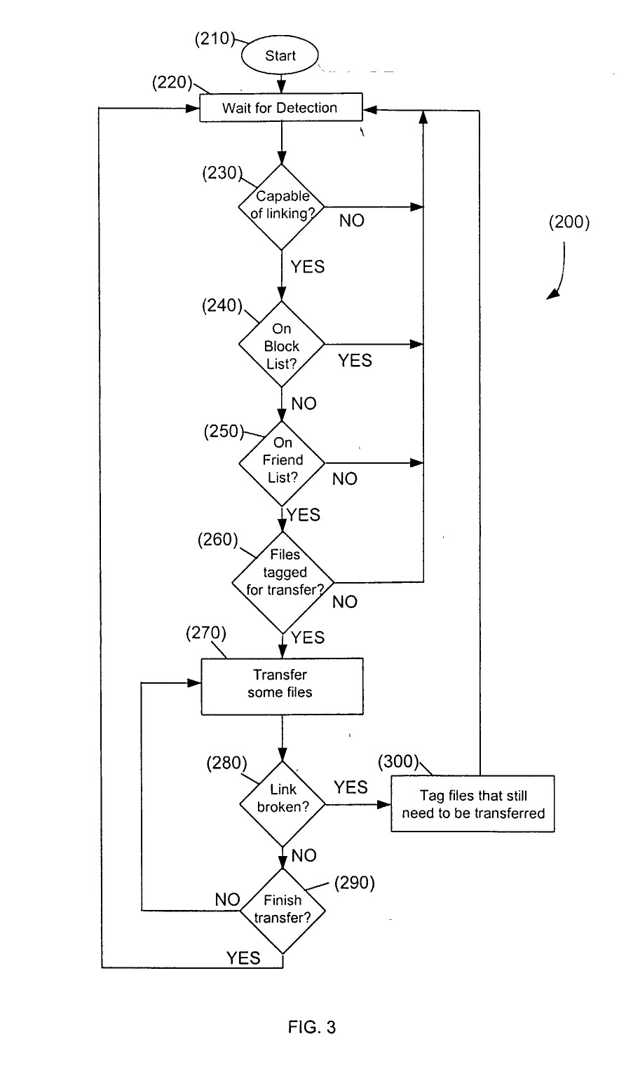

Referring to FIG. 3, a procedure (200) for transferring files between PDA's 40 and 50, absent user interaction, in conjunction with FIG. 2, may start (210) when power is applied to PDA 40. After starting (210), and for example, as the user carries PDA 40, the procedure (200) waits to detect (220), for example, PDA 50 broadcasting RF signals announcing its presence. Once a detection occurs, procedure (200) next determines if PDA 40 is capable of forming a communication link (230) with PDA 50. This determination may be based on information encoded in the RF signals broadcast by PDA 50. To form a link, for example, PDA 40 must be capable of decoding the RF signals to recover the transferred files. Also, for example, PDA 40 or PDA 50 may authenticate a digital signature to have a secure link. If PDA 50 is not capable of linking with PDA 40, procedure (200) returns to waiting for another detection (220).

If the detected PDA 50 is capable of linking, procedure (200) next checks if the PDA 50 has been entered on a “block” list (240) that may be stored on PDA 40. If PDA 50 was entered on the “block” list, PDA 40 does not form a communication link with PDA 50 and PDA 40 returns to waiting for another detection (220). If PDA 50 was not on the “block” list, then procedure (200) checks if PDA 50 in on a “friend” list (250).

PDA 40 checks to see if its user may have entered PDA 50 into the “friend” list (250). Generally, if the user would like to transfer files with PDA 50, the user would place PDA 50 on the “friend” list stored in the PDA 40. If PDA 50 is on the “friend” list, procedure (200) determines if files may have been tagged for transferring (260) between PDA 40 and PDA 50. If PDA 50 was not entered on the “friend” list, PDA 40 may not form a communication link with PDA 50 and PDA 40 returns to waiting for another detection (220).

If PDA 50 was entered on the “friend” list and there are tagged files for transferring between PDA 40 and PDA 50, PDA 40 establishes the communication link between PDA 40 and PDA 50 and the tagged files begin to transfer. PDA 40 and PDA 50 may also encrypt the tagged files before transferring to the other PDA. If no files are tagged for transferring between PDA 40 and PDA 50, procedure (200) returns PDA 40 to waiting for another detection (220).

While files are transferring between PDA 40 and PDA 50, procedure (200) monitors the received RF signals to determine if the communication link has been broken (280). If the communication link is unbroken, procedure (200) continues file transferring while checking if the file transfer has been completed (290). If the communication link is broken, before the completion of file transfer, procedure (200) tags the files not yet transferred (300) and returns PDA 40 to wait for another detection (220). By tagging the files not transferred (300), when the communication link is re-established after re-detecting PDA 50, procedure (200) may only transfer the tagged files and not re-transfer files transferred earlier. Once the file transferring is complete (290) procedure (200) returns the PDA 40 to wait for another detection (220).

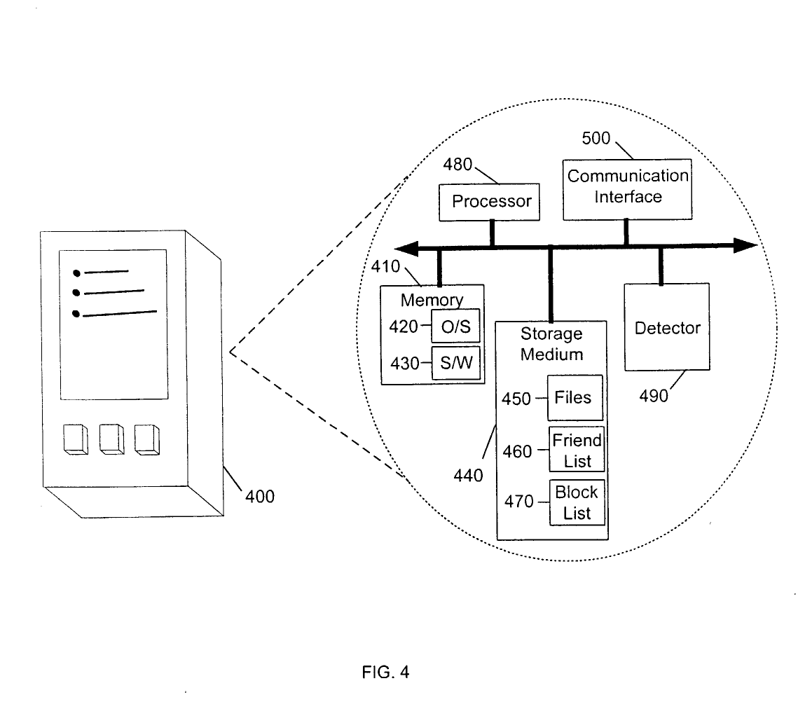

Referring to FIG. 4, PDA 400 includes a memory 410, which may store an operating system (O/S) 420 and software (S/W) 430 that may include instructions for procedure (200), described in conjunction with FIG. 3, and other functions described here. PDA 400 also includes a storage medium 440 (e.g., a hard disk, a flash memory, etc.) that stores files 450 that may be transferred to another PDA, after the other PDA has been detected by PDA 400. Storage medium 440 may also store a “friend” list 460 and a “block” list 470 that PDA 400 may access when determining whether to transfer files with the detected PDA. A processor 480 executes instructions, for example, the instructions of procedure (200) to detect another PDA, authorize file transfers, and transfer the files 450 to the detected PDA. PDA 400 also includes a detector 490 to detect RF signals broadcast other PDA's and a communication interface 500 to transmit and receive RF signals for transferring files 450 between PDA 400 and the detected PDA.

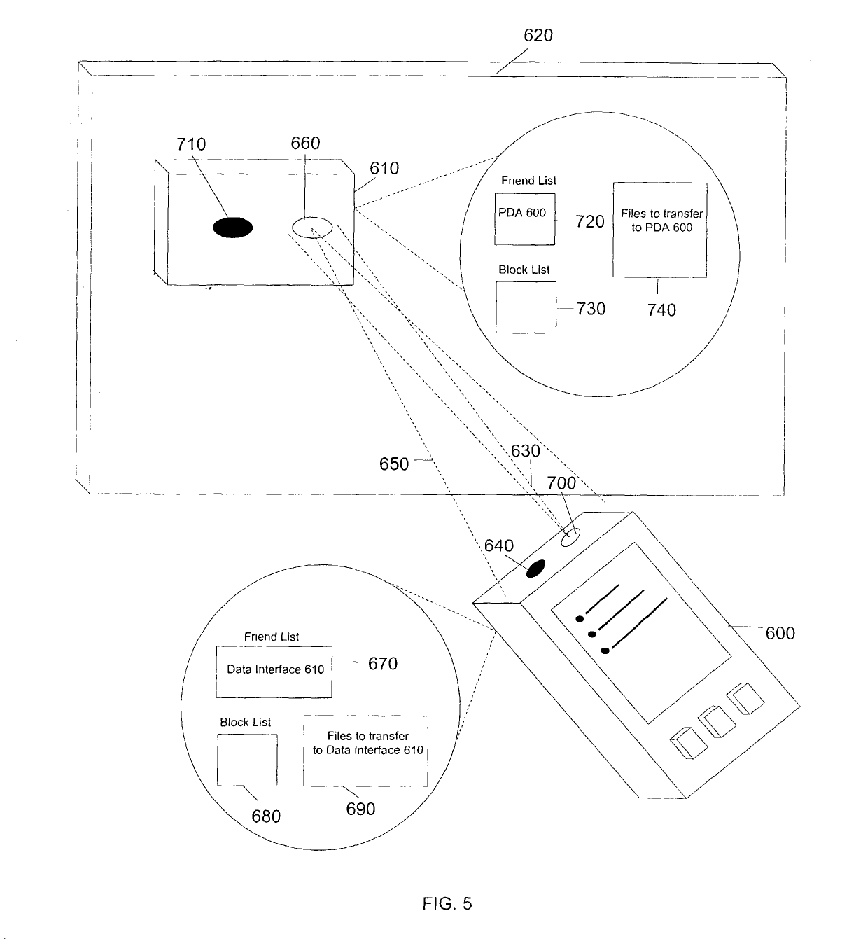

Referring to FIG. 5, in another example, a PDA 600 may establish a communication link with a data interface 610, again without interacting with the PDA's user, to allow file exchanging between the PDA and the data interface. The data interface 610 is mounted on a wall 620 to allow the PDA's user to easily position the PDA 600 near the wall 620 and establish a wireless RF link 630 between the PDA 600 and the data interface 610. By mounting the data interface 610 on the wall 620, numerous PDA's can form communication links with the data interface by simply passing near the wall 620. The relative location between the PDA 600 and the data interface 610 may also require less time to position than required for two PDA's to form a link, as shown in FIG. 2. Data interface 610 may also be positioned in various other locations, such as in a door frame or in a ceiling to provide easy access for the PDA 600. While the user carries the PDA 600 pass the wall-mounted data interface 610, multimedia files may exchange between the two digital devices. Thus, multimedia files may pass to the data interface 610, from the PDA 600, for storage until another PDA passes by the data interface and receives the multimedia files from the data interface. The data interface 610 may also pass multimedia files, being stored, to the PDA 600 which were sent by another person.

Similar to the PDA 400, shown in FIG. 4, the data interface 610 includes internal components to store, process, and exchange files between the data interface 610 and the PDA 600. The data interface also includes a communication interface 660, to transmit and receive RF signals encoded with files, or, for example, to broadcast an RF signal containing information identifying the data interface 610 as the source of the RF signal and announcing its presence. The data interface also may include a detector 710 that may detect RF signals broadcast by other digital devices in an attempt to form a communication link with the data interface 610.

When the user of PDA 600 positions the PDA near the wall 620, a detector 640, included in the PDA, may detect RF signals broadcast 650 from the communication interface 660 of the data interface 610. Communication interface 660 may broadcast the RF signals 650 to announce the presence of the data interface 610 to digital devices in the vicinity, such as PDA 600, so files may be exchanged with the data interface without the digital device interacting with its user. Similar to PDA 50, shown in FIG. 2, data interface 610 may broadcast RF signals 650 encoded with an identification so the PDA 600 may determine that the data interface 610 is the source of the broadcast 650. The broadcast 650 may also contain encoded information regarding encryption schemes and the receiving and transmitting parameters of the data interface 610 so that the PDA 600 may attempt to match the parameters for efficient file exchanging.

After detecting the data interface 610, the PDA 600 may access a “friend” list 670 and a “block” list 680, stored on the PDA 600 and similar to the lists discussed in conjunction with FIG. 2, the PDA may use both lists to determine whether to exchange files between the data interface 610 and the PDA without interacting with its user. If the data interface 610 is identified in the “friend” list 670, PDA 600 may exchange files with the data interface 610. Conversely, for example, if the data interface 610 was found in the “block” list 680, the PDA 600 may block file exchanges between the data interface 610 and the PDA. If the data interface 610 is not present on either list, PDA 600 may prompt the PDA's user to determine whether to enter the data interface 610 on the “friend” list 670, and allow file exchanging, or to enter the data interface 610 on the “block” list 680, and block file transfers. To prompt the user, the PDA 600 may sound an audible tone which is silenced after the user enters a response into the PDA.

Once PDA 600 detects, identifies, and determines that the data interface 610 is on the “friend” list 670, files 690 tagged for transfer to the data interface 610 may be exchanged between the data interface 610 and the PDA 600. The files 690 may be transferred by encoding the files into RF signals, as described in conjunction with FIG. 2, and transmitting the RF signals from a communication interface 700, included in PDA 600, over the wireless RF link 630 to the communication interface 660 for reception and storing of the files on the data interface 610.

Similarly data interface 610 may also store a “friend” list 720, a “block” list 730, and files 740 tagged to be transferred with PDA 600. After the PDA 600 has determined to transfer files with the data interface 610, the data interface may similarly determine to transfer files with the PDA. Data interface 610 may access the “friend” list 720 and the “block” list 730 to determine whether to exchange files with the PDA 600. Similarly, if the PDA 600 was entered into the “friend” list (as is the case here), the data interface 610 may transfer files with the PDA 600, while if the PDA was entered in the “block” list, the data interface may block file exchanging with the PDA. Generally, both the “friend” list and the “block” list are stored on the data interface 610 before the PDA 600 attempts to exchange files.

After the PDA 600 and the data interface 610 have determined to exchange files, PDA 600 transmits RF signals encoded with the files 690 to be transferred to the data interface 610 and the data interface transmits RF signals encoded with files 740 to be transferred to the PDA 600. Communication interface 660 transmits the RF signals from the data interface 610 and communication interface 700 transmits the RF signals from the PDA 600.

Similar to PDA 40, shown in FIG. 2, PDA 600 may monitor the file exchanging without interacting with its user. The data interface 610 may also monitor the file exchanging for interruptions. Also, as described in conjunction with FIG. 2, PDA 600 and data interface 610 may tag files not transferred, due to a transmission interruption and transfer the files at a later time when the wireless RF link 630 is re-established.

While the PDA 600 generally stores the files 690, the “friend” list 670, and the “block” list 680, the data interface 610 may also independently store the “friend” list 720, the “block” list 730, and the files 740 to be transferred to PDA 600. However, the data interface 610 may also be connected over a network to other digital devices (e.g., hubs, servers, etc.) storing the “friend” list 720, the “block” list 730, and the files 740 for exchanging with PDA 600. Once a wireless RF link 630 is established for file exchange between the PDA 600 and the data interface 610, the data interface may, for example, access a server for the files 740 to transfer to the PDA 600.

Other implementations are also within the scope of the following claims.

For example, in the implementation discussed in conjunction with FIG. 1, wireless digital PDA 10 transfers files to another digital device 20. However, other types of wireless digital devices may be used to transfer files, besides the wireless PDA 10, without interacting with its user. For example, computers, cell phones, pagers, or other similar wireless digital devices may be used individually, or in combination, to transfer files without interacting with a user.

In conjunction with FIG. 5, various digital devices, besides data interface 610, may form a wireless RF link 630 with the PDA 10. For example, asynchronous transfer mode (ATM) machines, computers, or other similar digital devices may exchange files with PDA 10 and may also be wall-mounted.

Also in conjunction with FIGS. 1, 2 and 5, various technologies may be implemented to establish a communication link with the wireless digital devices. Besides radio frequency (RF) signaling, infrared (IR) signaling, optical signaling, or other similar technologies may be used to implement communication links. RF signaling, IR signaling, optical signaling, or other similar signaling technologies may also be implemented individually or in combination to form the communication links for file exchanging.

In the examples described above, files were transferred, for example, between the two PDA's 40 and 50 shown in FIG. 2. Other types of data may also be transferred between these digital devices. For example, streams of digital data, individual digital bits, or other similar digital data may be transferred between the digital devices.

PDA 50 and data interface 610, in conjunction with FIG. 2 and FIG. 5, may broadcast RF signals from respective communication interface 90 and 660 to announce their presence to wireless digital devices in the vicinity. However, various types of identification signals may be transmitted by PDA 50 and data interface 610. For example, the identification signal may continuously transmit a generic message (e.g., “I'm Here”) to alert nearby PDA's. Or the identification signal may be encoded with information to particularly identify the source of the transmission, for example, the signal may be encoded with a digital signature. In still another example, the identification signals may transmit during predetermined intervals of time.

The detectors and communication interfaces, as shown in FIGS. 2 and 5, may be separate devices, or may be incorporated into a single detection/communication device that may reduce the number of wireless interfaces on the digital devices.

The procedure (200), described in conjunction with FIG. 3, is not limited to any particular hardware or software configuration; it may find applicability in any computing or processing environment. Procedure (200) may be implemented in hardware, software, or any combination of the two. Procedure (200) may be implemented in computer programs executing on machines (e.g., programmable computers) that each include a processor, a machine-readable medium readable by the processor (including volatile and non-volatile memory and/or storage elements), at least one input device, and one or more output devices. Procedure (200) may also be implemented in an application specific integrated circuit (ASIC). Program code may be applied to the data, received by the detector 490, in conjunction with FIG. 4, to perform procedure (200) and to generate output information. The output information may be applied to one or more devices, such as communication interface 500.

Each computer program may be implemented in a high-level procedural or object-oriented programming language to communicate with a computer system. However, the computer programs can be implemented in assembly or machine language, if desired. In any case, the language may be a compiled or interpreted language.

Each computer program may be stored on a machine-readable medium or device, e.g., random access memory (RAM), read only memory (ROM), compact disc read only memory (CD-ROM), hard disk drive, magnetic diskette, or similar medium or device, that is readable by a machine (e.g., a general or special purpose programmable computer) for configuring and operating the machine when the readable medium or device is read by the machine to perform procedure (200). Procedure (200) may also be implemented as a machine-readable storage medium, configured with a computer program, where, upon execution, instructions in the computer program cause the machine to operate in accordance with procedure (200).

Other embodiments are within the scope of the following claims. For example, procedure (200) may operate upon starting the PDA 400 and may execute continuously as the PDA operates.

What is claimed is:

1. A method of transferring data comprising:
using a wireless digital device to detect another digital device;
determining whether to transfer data from the wireless digital device to the other digital device based on information related to the data stored on the wireless digital device, the information provided by a user of the wireless digital device prior to the wireless digital device being used to detect the other digital device; and
transferring the data from the wireless digital device to the other digital device, without interacting with the user, if the wireless digital device determines to transfer the data.

2. The method of claim 1, further comprising,
terminating the transferring of the data from the wireless digital device to the other digital device, without interacting with the user.

3. The method of claim 2 wherein some the data does not transfer and further comprising,
tagging the data not transferred from the wireless digital device to the other digital device.

4. The method of claim 1, wherein the determining to transfer the data from the wireless digital device to the other digital device is based on whether the other digital device is on a “friend” list stored on the wireless digital device.

5. The method of claim 1, wherein the determining to transfer the data from the wireless digital device to the other digital device is based on whether the other digital device is on a “block” list stored on the wireless digital device.

6. The method of claim 1, further comprising,
transferring files from the wireless digital device to the other digital device, without interacting with the user, if the wireless digital device determines to transfer the files.

7. The method of claim 1, further comprising,
using the wireless digital device to probe the other digital device for data transmitting parameters, without interacting with the user.

8. The method of claim 1, further comprising,
prompting the user of the wireless digital device to determine whether to transfer data between the wireless digital device and the other digital device.

9. The method of claim 1, further comprising,
broadcasting an identification signal from the other digital device.

10. The method of claim 1, further comprising,
blocking the transferring of the data from the wireless digital device to the other digital device, without interacting with the user.

11. The method of claim 1, further comprising,
tagging the data stored on the wireless digital device for transferring to the other digital device before detecting the other digital device.

12. A wireless digital device comprising:
a detector configured to detect another digital device;
a processor to execute instructions; and
a memory storing instructions capable of causing the processor to,
determine whether to transfer data from the wireless digital device to the other digital device based on information related to the data stored on the wireless digital device, the information provided by a user of the wireless digital device prior to detecting the other digital device, and
transfer the data from the wireless digital device to the other digital device, without interacting with the user, if the wireless digital device determines to transfer the data.

13. The wireless digital device of claim 12, wherein the instructions include causing the processor to terminate the transferring of the data from the wireless digital device to the other digital device, without interacting with the user.

14. The wireless digital device of claim 13, wherein the instructions include causing the processor to tag the data not transferred from the wireless digital device to the other digital device.

15. The wireless digital device of claim 12, wherein the instructions include causing the processor to probe the other digital device for data transmitting parameters, without interacting with the user.

16. The wireless digital device of claim 12, wherein the instructions include causing the processor to prompt the user of the wireless digital device to determine whether to transfer the data from the wireless digital device to the other digital device.

17. The wireless digital device of claim 12, wherein the instructions include causing the processor to broadcast an identification signal from the wireless digital device, without interacting with the user.

18. The wireless digital device of claim 12, wherein the instructions include causing the processor to block the transferring of the data from the wireless digital device to the other digital device, without interacting with the user.

19. The wireless digital device of claim 12, wherein the instructions include causing the processor to tag the data stored on the wireless digital device for transferring to the other digital device before the detector detects the other digital device.

20. An article comprising a machine-accessible medium that stores instructions capable of causing a wireless digital device to:
determine if a detector, included in the wireless digital device, has detected another digital device;
determine whether to transfer data from the wireless digital device to the other digital device based on information related to the data stored on the wireless digital device, the information provided by a user of the wireless digital device prior to detecting the other digital device; and
transfer the data from the wireless digital device to the other digital device, without interacting with the user, if the wireless digital device determines to transfer the data.

21. The machine-accessible medium of claim 20, wherein the instructions are further capable of causing the wireless digital device to terminate the transferring of the data from the wireless digital device to the other digital device, without interacting with the user.

22. The machine-accessible medium of claim 21, wherein the instructions are further capable of causing the wireless digital device to tag the data not transferred from the wireless digital device to the other digital device.

23. The machine-accessible medium of claim 20, wherein the instructions are further capable of causing the wireless digital device to probe the other digital device for data transmitting parameters, without interacting with the user.

24. The machine-accessible medium of claim 20, wherein the instructions are further capable of causing the wireless digital device to prompt the user of the wireless digital device to determine whether to transfer the data from the wireless digital device to the other digital device.

25. The machine-accessible medium of claim 20, wherein the instructions are further capable of causing the wireless digital device to broadcast an identification signal, without interacting with the user.

26. The machine-accessible medium of claim 20, wherein the instructions are further capable of causing the wireless digital device to block the transferring of the data from the wireless digital device to the other digital device, without interacting with the use.

27. The machine-accessible medium of claim 20, wherein the instructions are further capable of causing the wireless digital device to tag the data stored on the wireless digital device for transferring to the other digital device before the detector detects the other digital device.

28. A method of transferring files comprising:
using a first wireless digital device to detect a second wireless digital device;
determining whether to transfer files from the first wireless digital device to the second wireless digital device based on information related to the files stored on the wireless digital device, the information provided by a user of the first wireless digital device and on information provided by a user of the second wireless digital device prior to detecting the second wireless digital device; and
transferring the files from the first wireless device to the second wireless device, without interacting with the user of the first wireless digital device and the user of the second wireless digital device.

29. The method of claim 28, wherein the determining to transfer the files from the first wireless digital device to the second wireless digital device is based on whether the second wireless digital device is on a first “friend” list stored on the first wireless digital device and the first wireless is on a second “friend” list stored on the second wireless digital device.

30. The method of claim 28, wherein the determining to transfer the files from the first wireless digital device to the second wireless digital device is based on whether the second wireless digital device is on a first “block” list stored on the first wireless digital device and whether the first wireless digital device is on a second “block” list stored on the second wireless digital device.
